(19) United States
(12) Patent Application Publication
(10) Pub. No.: US 2004/0131004 A1
(43) Pub. Date: Jul. 8, 2004

(54) Optical pick-up apparatus

(75) Inventors: Mitsuru Mimori, Tokyo (JP); Yuichi Atarashi, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/741,443

(22) Filed: Dec. 22, 2003

(30) Foreign Application Priority Data
Dec. 26, 2002 (JP) JP2002-376361
Feb. 20, 2003 (JP) JP2003-042695

(51) Int. Cl. G11B 7/135

(52) U.S. Cl. 369/121; 369/112.08

(57) ABSTRACT

First and second light sources, an objective optical element, a photo-detector, first and second coupling elements and a beam splitter are arranged such that a first light flux emitted from the first light source comes into the objective optical element through the first coupling element and the beam splitter and forms a converged light spot on an information recording plane of a first optical information recording medium, a second light flux emitted from the second light source comes into the objective optical element through the second coupling element and the beam splitter and forms a converged light spot on an information recording plane of a second optical information recording medium, and the first and second light fluxes forming the respective converged light spots are reflected from the respective information recording planes and thereafter pass through the objective optical element, the beam splitter and the second coupling element and come into the photo-detector.

### BACKGROUND OF THE INVENTION

The present invention relates to an optical pick-up apparatus, in more details, to the optical pick-up apparatus which can cope with the standards of a plurality of optical information recording media (optical disks).

From the past up to now, an optical pick-up apparatus (called an optical head, or optical head apparatus) for reproducing • recording the optical information recording medium (called optical disk or media) such as a CD (compact disk), DVD (digital video disk, or digital versatile disk) is developed • produced, and spread in common.

Further, recently, also relating to the standard of the optical information recording medium in which the higher density information recording can be conducted, the research and development are conducted.

Then, these optical pick-up apparatus reproduces the information in such a manner that it forms a spot by light converging the light flux emitted from a light source (mainly, a laser diode is used) on the information recording surface of the optical disk through the optical system composed of the optical element such as a beam shaping prism, collimator, beam splitter, objective optical element, and the reflected light from the information recording hole (called also a pit) on the recording surface is light converged on a sensor this time through the optical system again, and when it is converted into the electric signal, the information is reproduced. In this case, because the light flux of the reflected light is also changed depending on the shape of the information recording hole, it is utilized and the information of “0”, “1” is discriminated.

Hereupon, a protective substrate (plastic-made protective layer, also called a cover glass) is provided on the information recording surface of the optical disk.

Further, when the information is recorded in the recording type media such as CD-R, CD-RW, a spot by the laser light flux is formed on the recording surface, and the thermal chemical change is made to generate in the recording material on the recording surface. Thereby, in the case of, for example, CD-R, when the thermal diffusion die is irreversibly changed, the shape as same as the information recording hole is formed. In the case of CD-RW, because the phase change type material is used, and because, by the thermal chemical change, it is reversibly changed between the crystal state and the amorphous state, the rewriting of the information is possible.

Then, in the optical pick-up apparatus for reproducing the information from the optical disk of the CD standard, NA of the objective lens is about 0.45, and the wavelength of the light source to be used, is about 785 nm. Further, as the NA of the objective lens for the recording, there are many cases where about 0.50 NA is used. Hereupon, the protective substrate thickness of the optical disk of the CD standard is 1.2 mm.

Then, the CD is widely spread as the optical information recording medium, and in this several years, the DVD is spread. This is structured in such a manner that the protective substrate thickness is more decreased compared to the CD, and further, when the diameter of the information recording hole is reduced, the information recording amount is increased, and to the fact that the CD is about 600-700 MB (mega bytes), there are many cases where it has the recording capacity of the large capacity of about 4.7 GB (giga bytes), and is used as the distribution medium in which the moving images of the movie are recorded.

Further, although the optical pick-up apparatus for reproducing the information from the optical disk of the DVD standard is principally thee same as that for the CD, because the diameter of the information recording hole is reduced as described above, an apparatus in which the NA of the objective lens is about 0.60, and the wavelength of the light source to be used is about 655 nm, is used. Further, in many cases, as the objective lens for the recording, the lens whose NA is about 0.65 is used. Hereupon, the thickness of the protective substrate of the optical disk of the DVD standard is 0.6 mm.

Further, also for the optical disk of the DVD standard, the optical disk of the recording type is already put into practical use, and there is each standard such as the DVD-RAM, DVD-RW/R, and DVD+RW/R. The engineering principle for these disks, is also the same as the case of the CD standard.

Then, as described above, the further high density and high capacity optical disk is being proposed. This is the disk for which, mainly as the light source, so called blue violet laser light source whose wavelength is about 405 nm is used.

For such a “high density optical disk”, even when the wavelength to be used is determined, the protective substrate thickness, storage capacity, and NA are not uniformly determined. When the direction to widely increase the recording density is selected, the protective substrate thickness of the optical disk is reduced, and accompanying that, the NA is increased. Reversely, the protective substrate thickness and NA can also be made the same as the standard of the conventional optical disk such as the DVD. In this case, the physical recording density is not largely increased, however, the performance required as the optical system is comparatively moderated.

Specifically, a disk in which the thickness of the protective substrate is further reduced into 0.1 mm, or it is made 0.6 mm which is the same as the DVD, is proposed.

Hereupon, also for the optical pick-up apparatus and the information recording reproducing apparatus for the optical disks such as these disks, the smaller type apparatus is requested accompanying the size reduction of the instrument to be mounted.

For this purpose, the reduction of the number of the optical elements or optical members in the optical system is also considered, for example, not only the light sources of two wavelength are integrated, but also the optical pick-up apparatus in which the light source unit whose optical detectors are integrated is adopted is well known (for example, refer to patent document 1).

The light source unit in which the light sources of two wavelengths are integrated, is sometimes called also 2 wavelength 1 package. When this 2 wavelength 1 package light source unit is adopted, the light source of the side for which the accuracy is requested, is arranged so that it is placed on the optical axis. For example, when they are the DVD light source and the CD light source, the DVD light source is arranged on the optical axis. Accordingly, the other one is arranged at the position separated from the optical axis, and the gap between mutual light emitting points is about 100-110 μm which is minute, however, the image height is generated because it is dislocated from the optical axis.

In this patent document 1, so called a holo-laser (called also hologram laser apparatus) in which the light detector and the hologram element are further integrated with the light source, is disclosed.

When such a light source • light receiving element unit is used, the light flux emitted from the light source enters into the light path as it is, and finally forms the light converging spot on the information recording surface of the optical disk, and returns to the light source • light receiving element unit via the same path, however, the light path is curved by an element for the wavelength separation or hologram element, and it is incident on the light receiving element provided adjoining the light source.

Further, from the past, there is a problem that the refractive index of the lens (for example, a coupling lens) constituting the optical pick-up apparatus is lowered accompanied by the temperature variation, and the change of the divergent angle of the emitting light flux from the coupling lens is caused, as a result, (in the case of the optical system in which the distance from the light source to the optical information recording medium and the distance from the optical information recording medium to the light detector do not have the conjugate relationship) the image formation position is changed, and the error (focus offset) is generated in the signal for the focus control.

Accordingly, when, by using the wavelength change of the light source caused by the temperature rise of the optical pick-up apparatus, the focal distance variation caused by the refractive index lowering is cancelled by the focal distance change of the diffracting action in the diffractive structure provided in the coupling lens, the temperature correction technique by which the divergent angle of the emitting light flux from the coupling lens is not changed, is well known (for example, refer to patent document 2).

[patent document 1]

Tokkai No. 2002-358661

[patent document 2]

Tokkai No. 2001-159731

As described above, by the engineering of the patent document 1, from a point that the image height is generated, there is a problem that it is particularly un-preferable for the use of the writing system. Further, the light source unit and the light receiving unit are integrated, and there is an advantage that they can be small size and compact, however, on the other hand, from a point that the image height is generated, there is a difficult point in its application to a so-called writing system in which the information can be recorded.

Further, for both wavelengths, because the length of the light path from the light source to the recording medium is about equal, it is necessary to make the magnification equal, and therefore, the optimum magnification can not be selected for each wavelength, and basically, it is necessary that they are made to be the infinite system (the parallel light is incident on the objective optical element) optical system. That is, as a result, the collimator element is necessary, and it becomes difficult to reduce the number of optical elements.

Then, because 2 wavelengths track almost the same optical path, there is a problem in which it is also difficult that the temperature correction which is optimized for each is conducted. Further, also when the hologram laser apparatus is produced, it becomes necessary to make accurate respective of the element for the wavelength separation, hologram element and light source portion, and results in the cost up.

Further, in the case of the optical pick-up apparatus of the patent document 2, because the diffracting power is strongly necessary at the time of the temperature rise, as the result, there is a problem that the number of the diffractive ring-shaped zones becomes large, and the complicate-ness of the coupling production process or the high accurate production engineering becomes necessary, resulting in the increase of the production cost.

### SUMMARY OF THE INVENTION

In an object of the present invention, the above-described problem is considered, and the object of the present invention is to provide an optical pick-up apparatus in which the image height is not generated also for the optical information recording medium of a plurality of standards, and the individual temperature correction is possible, further, the cost reduction is possible, and which can be accurately assembled, and has the interchangeability.

The invention of the present application is attained by any one of the following structures.

(1) In an optical pick-up apparatus by which, for the first optical information recording medium of the substrate thickness t1, the reproduction and/or recording of the information is conducted by using the first light source of the wavelength λ1, and for the second optical information recording medium of the substrate thickness t2 (t1≦t2), the reproduction and/or recording of the information is conducted by using the second light source of the wavelength λ2 (λ1<λ2), which is characterized in that: it has an objective optical element commonly used for both of the first optical information recording medium and the second optical information recording medium, an light detector for detecting the reflected light from the information recording surface of the optical information recording medium, the first coupling element by which the divergent angle of the light flux which is incident from the first light source is changed and emitted, the second coupling element by which the divergent angle of the light flux which is incident from the second light source is changed and emitted, and a beam splitter arranged between the objective optical element and the first coupling element; and on at least one side of the first coupling element and the second coupling element, the optical functional surface for the temperature correction for the light source of the first wavelength is provided, and the first light source and the second light source, objective optical element, light detector, and the first coupling element and the second coupling element, and the beam splitter are arranged so that light flux emitted from the first light source is incident on the objective optical element through the first coupling element and the beam splitter and forms a light converging spot on the information recording surface of the first optical information recording medium, and light flux emitted from the second light source is incident on the objective optical element through the second coupling element and the beam splitter and forms a light converging spot on the information recording surface of the second optical information recording medium, and after both of the light fluxes which formed the light converging spot, are reflected on the information recording surface of the optical information recording medium, those elements are arranged so that these reflected light flux are incident on the light detector after they transmit the objective optical element, beam splitter, and the second coupling element.

(2) An optical pick-up apparatus according to (1), which is characterized in that: the optical functional surface for the temperature correction for the light source of the first wavelength is provided on the first coupling element.

(3) An optical pick-up apparatus according to (1), which is characterized in that: the optical functional surface for the temperature correction for the light source of the first wavelength is provided on the second coupling element.

(4) An optical pick-up apparatus according to any one of (1)-(3), which is characterized in that: a collimator element is provided between the beam splitter and the objective optical element.

(5) An optical pick-up apparatus according to any one of (1)-(4), which is characterized in that: the first coupling element has a collimator function.

(6) An optical pick-up apparatus according to any one of (1)-(5), which is characterized in that: the second coupling element has a collimator function.

(7) An optical pick-up apparatus according to any one of (1)-(6), which is characterized in that: the light detector is a holo-laser unit which is integrally structured with the second light source, and the holo-laser unit has a hologram element, and the light flux reflected on the information recording surface of the optical information recording medium is incident on the light detector by the hologram element.

(8) An optical pick-up apparatus according to any one of (1)-(6), which is characterized in that: 2 light detectors are provided, and the hologram element having the wavelength selectivity is provided, and it is structured in such a manner that the light flux of the wavelength λ1 reflected on the information recording surface of the first optical information recording medium, and the light flux of the wavelength λ2 reflected on the information recording surface of the second optical information recording medium, are respectively incident on the separate light detectors.

(9) An optical pick-up apparatus according to any one of (1)-(8) which is characterized in that: the optical functional surface for the temperature correction is a diffractive structure.

(10) An optical pick-up apparatus according to any one of (1)-(9), which is characterized in that: in the situation before the temperature rise, when the light flux of the wavelength λ1 emitted from the first light source passes the first coupling element, an angle in which the light flux of the wavelength λ1 forms to the optical axis, is made θ1, and in the situation before the temperature rise, when it is supposed that the light flux of the wavelength λ1 is emitted from the second light source, an angle in which the light flux of the wavelength λ1 forms to the optical axis when the light flux of the wavelength λ1 passes the second coupling element, is made θ2, and in the situation after the temperature rise, when the light flux of the wavelength λ1 emitted from the first light source passes the first coupling element, an angle in which it forms to the optical axis is made θ1′, and in the situation after the temperature rise, when it is supposed that the light flux of the wavelength λ1 is emitted from the second light source, an angle in which the light flux of the wavelength λ1 forms to the optical axis when the light flux of the wavelength λ1 passes the second coupling element, is made θ2′, when the focal distance of the first coupling element is f1 to the light flux of the wavelength λ1, and the focal distance of the second coupling element is f2, f1>f2, θ1=θ2, θ1′=θ2′, θ1′>θ1 are satisfied. Where, in θ1, θ1′, θ2, θ2′, the direction to which the light flux is diverged, is defined as positive.

(11) An optical pick-up apparatus according to (9) or (10), which is characterized in that: the diffractive structure is structured by a plurality of concentric circular diffractive ring-shaped zones around the optical axis, and the step difference surface which is arranged almost in parallel with the optical axis, and which joins 2 mutual diffractive ring-shaped zones adjoining in the diameter direction, and the step difference surface is arranged facing the reversal side to the optical axis.

(12) An optical pick-up apparatus according to (11), which is characterized in that: when an additional amount of the light path length by the diffractive structure is expressed by the light path difference function φ(h) defined by φ(h)=(B₂h²+B₄h⁴+B₆h⁶+ . . . BₙHⁿ), by using the coefficient Bn of the light path difference function of n-order (n is even number), B₂>0 is satisfied.

(13) An optical pick-up apparatus according to (11) or (12), which is characterized in that: the second diffractive structure having a plurality of concentric circular diffractive ring-shaped zones abound the optical axis is provided, and when a focal distance to the light flux of the wavelength λ1 of the objective optical element is f, the diffraction order of the diffracted ray having the maximum diffraction efficiency in the diffracted ray of the light flux of the wavelength λ1 by the diffractive structure, is N (N≠0), and when the number of the diffractive ring-shaped zones of the second diffractive structure is L, 9<NL/f<39 is satisfied.

### BRIEF DESCRIPTION OF THE DRAWINGS

FIG. 1 is a view of an optical pick-up apparatus according to the present invention.

FIG. 2 is a view of the optical pick-up apparatus of another mode according to the present invention.

FIGS. 3(a), (b) are drawings for explaining a temperature correction function.

FIG. 4 is a drawing for explaining a temperature correction function.

FIG. 5 is a main portion plan view showing the structure of the first coupling element in an example.

FIG. 6 is a graph showing a change of a focal distance to a temperature change.

FIG. 7 is a graph showing a change of the spherical aberration to the temperature change.

### DETAILED DESCRIPTION OF THE PREFERRED EMBODIMENT

Referring to the drawings, a content of the present invention will be detailed below, however, the embodiment of the present invention is not limited to them.

Further, in the present example, mainly the interchange of a CD and a DVD is described, however, it is of course that it can also apply to the interchange of the “high density optical disk” using the blue violet laser light and the existing optical disks (CD and DVD). Further, it can also apply to the interchange among standards of 3 optical disks in which these 3 standards are mixed.

(The First Embodiment)

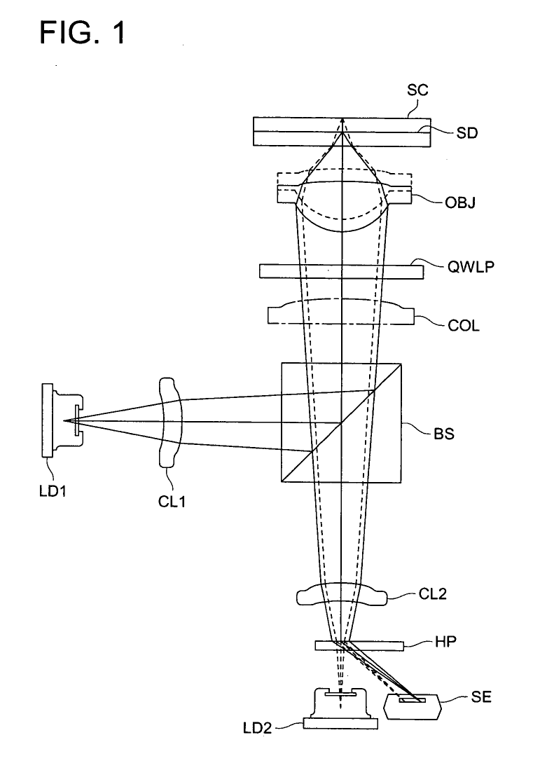

By using FIG. 1, the invention of an item 1 will be described below. FIG. 1 is a typical view showing an optical pick-up apparatus according to the invention of the present application.

In the present example, the DVD using a red laser of the wavelength λ1 of 655 nm and the CD using the infrared laser of the wavelength λ2 of 780 nm are target, and as the first optical information recording medium, the DVD whose protective substrate thickness t1 is 0.6 mm, and as the second optical information recording medium, the CD whose protective substrate thickness t2 is 1.2 mm, are presupposed.

A laser diode LD1 is the first light source, and the red laser whose wavelength λ1 is 655 nm is used, however, a light source whose wavelength is in the range of 630-680 nm can be properly adopted. An LD2 is the second light source, and the infrared laser whose wavelength λ2 is 780 nm is used, however, a light source whose wavelength is in the range of 750-800 rim can be properly adopted.

In the drawing, lines which extend from LD1 and LD2 and reach SE respectively show the light flux, and a solid line shows the light flux for the DVD emitted from the LD1, and a dotted line shows the light flux for the CD emitted from the LD2.

In this optical system, both are systems using the finite divergent light, however, it may also have a structure in which a collimator COL shown by a one-dotted chain line is provided at the position of the view, and a parallel light (infinite light) is incident on the objective lens.

Symbols SD and SC are information recording surfaces of the DVD which is the first optical information recording medium, and the CD which is the second optical information recording medium. In the DVD and CD, the thickness of the protective substrates are different, and in this example, in order to easily understand, it is drawn so that positions of the protective substrate surfaces are same, however, it can be properly changed in the design work.

An objective lens OBJ which is an objective optical element, is a single lens formed of the plastic, however, it may also be structured by combining a plurality of plastic lenses, and a glass lens can also be used. Further, a hybrid lens can also be adopted.

Herein, the optical functional surface of the objective lens OBJ is divided into 2 concentric circular areas around the optical axis (a central area and a peripheral area), and a different diffractive structure is provided in respective areas. By this diffractive structure, when the DVD is used, the light flux emitted from an LD1 passes both of the central area and peripheral area, and forms a light converging spot on the information recording surface of the DVD which is the first optical information recording medium. When the CD is used, the light flux emitted from an LD2 passes the central area, and forms the light converging spot on the information recording surface of the CD which is the second optical information recording medium. However, it is structured in such a manner that the light flux of the LD2 which has passed the peripheral area, becomes a flare light, and is not light converged.

In the objective lens OBJ, the reference positions are respectively changed at the time of use of the DVD and the CD, and the focusing is conducted from respective reference positions. Herein, the solid line shows the time of use of the DVD, and dotted line shows the time of use of the CD.

When the DVD is used, the light flux emitted from the LD1 is incident on a coupling lens CL1 which is the first coupling element, a divergent angle is reduced, and it is incident on a beam splitter BS. The light path is curved herein, it is incident on the objective lens OBJ, and forms a light converging spot on an SD which is the information recording surface of the DVD. Then, it is reflected and a polarized direction is changed through a ¼ wavelength plate QWLP and it is incident on the beam splitter BS again, and emitted to a coupling lens CL2 this time which is the second coupling element. Then, in the situation in which a convergent angle is increased by the second coupling element, it is incident on a diffraction plate HP. This diffraction plate HP has the wavelength selectivity, and is structured in such a manner that the longer the wavelength of the light flux is, it is light converged on the more separated position from the optical axis. The incident light flux is light converged on a light detector SE structured by a photodiode, and converted into the electric signal.

When the CD is used, the light flux emitted from the LD2 is incident on a coupling lens CL2 which is the second coupling element, the divergent angle is reduced, and incident on the beam splitter BS. Herein, the light path is not changed, and incident on the objective lens OBJ, and forms a light converging spot on an SC which is the information recording surface of the CD. The light path is curved in the same manner herein, and it is light converged on a position nearer a light source side, and converted into the electric signal in the same manner.

Now, herein, as an optical functional surface for the temperature correction, it is structured in such a manner that the temperature characteristic for the light flux of the wavelength λ1 emitted from the first light source is corrected by providing the diffractive structure on the emitting surface (surface of the image side) of the first coupling element CL1.

A correction method of the temperature characteristic will be specifically described below.

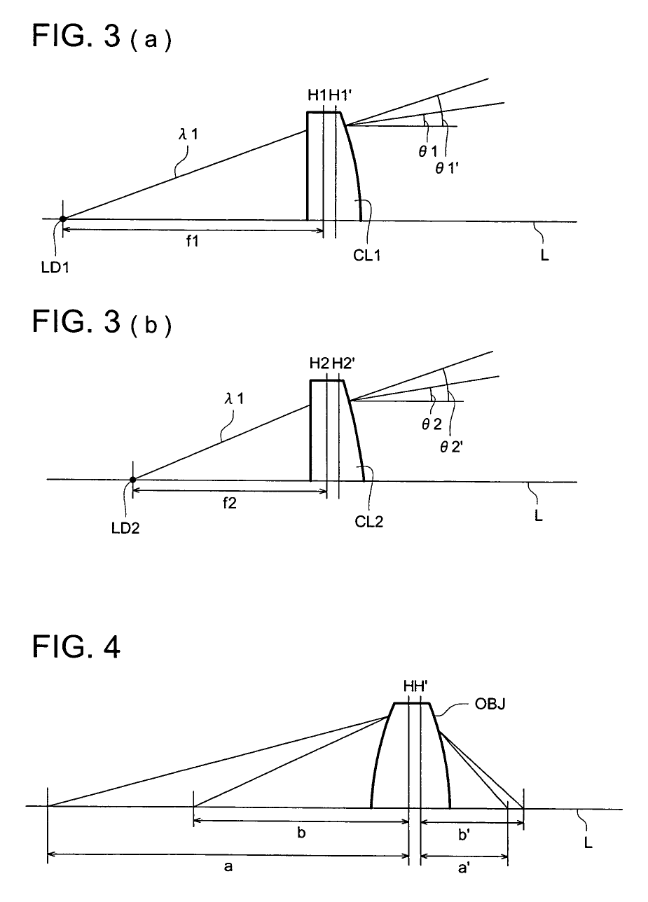

As shown in FIG. 3(a), initially, before the temperature rise (normal situation), when the light flux of the wavelength λ1 emitted from the first light source LD1 passes the first coupling element CL1, an angle in which it forms to the optical axis is defined as θ1, and after the temperature rise (high temperature situation), when the light flux of the wavelength λ1 emitted from the first light source passes the first coupling element, an angle in which it forms to the optical axis is defined as θ1′. Further, the distance (an object distance) from the light source LD1 to a principal point H1 (a front side principal point) is defined as f1. Hereupon, a symbol H1′ shows a rear side principal point.

The light flux of the wavelength λ1 is, even in the normal situation or high temperature situation, when it passes the first coupling element CL1, it receives the diffracting action by the diffractive structure.

Next, as shown in FIG. 3(b), when it is supposed that the light flux of the wavelength λ1 is emitted from the second light source, in the normal situation, when the light flux of the wavelength λ1 passes the second coupling element CL2, an angle in which it forms to the optical axis is defined as θ2, and in the high temperature situation, when this light flux of the wavelength λ1 passes the second coupling element CL2, an angle in which it forms to the optical axis is defined as θ2′. Further, the distance (an object distance) from the light source LD2 to a principal point H2 of the coupling element CL2 is defined as f2. Hereupon, a symbol H2′ shows a rear side principal point.

Hereupon, on the second coupling element CL2, the diffractive structure for the temperature correction is not provided.

Further, in θ1, θ1′, θ2, and θ2′, a direction to which the light flux is diverged, is defined as positive.

Then, in the present embodiment, the focal distance f1 of the first coupling element CL1 to the light flux of the wavelength λ1, is made larger (f1>f2) than the focal distance f2 of the second coupling element CL2 to the light flux of the wavelength λ1, and together with this, the diffractive structure gives the diffracting action to the light flux of the wavelength λ1 so that, in the normal situation, when the light flux of the wavelength λ1 passes the first coupling element CL1, an angle θ1 in which it forms to the optical axis is equal to θ2 (θ1=θ2), and the diffractive structure gives the diffracting action to the light flux of the wavelength λ1, in the high temperature situation, so that, when the light flux of the wavelength λ1 passes the first coupling element CL1, an angle θ1′ in which it forms to the optical axis is equal to θ2′ (θ1′=θ2′)

Further, in the present embodiment, the diffracting action is given by the diffractive structure so as to be θ1′>θ1. This is, for example, as disclosed in Japanese Tokkai No. 2001-159731, by enhancing the diffracting power by the diffractive structure at the time of temperature rise, the emitting angle of the emitting light flux from the coupling lens is not changed, that is, it is different from the engineering which is conventionally well known, and in which θ1′=θ1 is made, and it is the characteristic part of the present invention.

Next, an effect in which the diffracting action is given as described above, for the light flux of the wavelength λ1, so that f1>f2, in the normal situation, θ1=θ2, in the hot temperature situation, θ1′=θ2′, will be described.

Initially, in the normal situation, the light flux of the wavelength λ1 which receives the diffracting action so that, when it passes the first coupling element CL1, an angle which forms to the optical axis L is θ1, after that, passes the objective lens OBJ and reaches the information recording surface SD of the DVD. Then, it is reflected on the information recording surface SD of the DVD, passes the beam splitter BS, and reaches the surface of the image side of the second coupling element CL2 in the situation in which an angle forming to the optical axis L is θ1.

Herein, as described above, when temporarily the light flux of the wavelength λ1 is emitted from the second light source LD2, in the normal situation, the light flux of the wavelength λ1 is processed in such a manner that, in the second coupling element CL2, its advancing direction is changed so that an angle which forms to the optical axis L is θ2, and it is emitted from the surface of the image side. This means, in other words, that the light flux of the wavelength λ1 whose angle forming to the optical axis is θ2 and which reaches the surface of the image side of the second coupling element CL2 whose advancing direction is changed so that it is converged to the second light source LD2, and emitted from the surface of the object side.

Then, as described above, in the present embodiment, by the diffracting action which is given to the light flux of the wavelength λ1 by the diffractive structure, θ1=θ2 is realized. Accordingly, the light flux of the wavelength λ1 which reaches the surface of the image side of the second coupling element CL2 in the situation that an angle which is formed to the optical axis is θ1, is processed in such a manner that its advancing direction is changed so that it is converged to the second light source LD2, and is emitted from the surface of the object side.

Then, it is structured in such a manner that the light path of the light flux of the wavelength λ1 is, before it reaches the second light source, curved by the diffraction plate HP arranged between the second coupling element CL2 and the second light source LD2, and light converged on the light detector SE.

On the one hand, in the high temperature situation, when it passes the first coupling element CL1, the light flux of the wavelength λ1 which receives the diffracting action so that an angle in which it forms to the optical axis is θ1′ passes the objective lens OBJ after that, and reaches the information recording surface SD of the DVD. Then, it is reflected on the information recording surface SD of the DVD, passes the beam splitter BS and reaches the surface of the image side of the second coupling element CL2 in the situation in which an angle which forms to the optical axis is θ1′.

Herein, as described above, when temporarily the light flux of the wavelength λ1 is emitted from the second light source LD2, in the normal situation, the light flux of the wavelength λ1 is, in the second coupling element CL2, its advancing direction is changed so that an angle in which it forms to the optical axis L is θ2′, and is emitted from the surface of the image side. In other words, this means that in the light flux of the wavelength λ1 which reaches the surface of the image side of the second coupling element CL2 under the condition in which an angle in which it forms to the optical axis L is θ2′, its advancing direction is changed so that it is converged to the second light source LD2, and is emitted from the surface of the object side.

Then, as described above, in the present embodiment, by the diffracting action which is given to the light flux of the wavelength λ1 by the diffractive structure, θ1′=θ2′ is realized.

Accordingly, in the light flux of the wavelength λ1 which reaches the surface of the image side of the second coupling element CL2 under the condition in which an angle in which it forms to the optical axis is θ1′, its advancing direction is changed so that it is converged to the second light source LD2, and it is emitted from the surface of the object side.

Then, the system is structured in such a manner that, before the light flux of the wavelength λ1 reaches the second light source LD2, its light path is curved by the diffraction plate HP arranged between the second coupling element CL2 and the second light source LD2, and it is light converged on the light detector SE.

Herein, in the general optical pick-up apparatus which is not provided with the optical functional surface for the temperature correction according to the present invention, in the normal situation, the light flux of the wavelength λ1 emitted as, for example, the parallel light (θ1=0) from the first coupling element is reflected on the optical information recording medium (DVD), is incident on the second coupling element as the parallel light, and as shown in FIG. 4, is converged on one point on the optical axis at which the object distance (a distance from the front side principal point H to the front side focal point) is a. On the one hand, in the high temperature situation, the light flux of the wavelength λ1 emitted from the first coupling element under the condition in which an angle in which it forms to the optical axis is θ1′ (θ1′>θ1), is reflected on the optical information recording medium (DVD), is incident on the second coupling lens under the condition that an angle in which it forms to the optical axis is θ1′, and converged to one point on the optical axis at which the object distance is b (b<a).

In this case, when an image distance (a distance from the rear side principal point H′ to the rear side focal point) of the light flux of the wavelength λ1 in the normal situation, is a′, and an image distance in the high temperature situation is b′, in the normal situation, in the image formation magnification |a′/a| of the objective lens to the light flux of the wavelength λ1 and in the high temperature situation, the image formation magnification |b′/b| of the objective lens to the light flux of the wavelength λ1, the relationship of |a′/a|<|b′/b| is realized.

However, in the optical pick-up apparatus according to the present invention, as described above, by giving the diffracting action to the light flux of the wavelength λ1 by the diffractive structure provided on the first coupling element CL1, object distances a and b are made equal, that is, the light path from after the light flux of the wavelength λ1 reflected on the information recording surface SD passes the objective lens OBJ to it reaches the light detector SE, is made equal in the normal situation and high temperature situation, and relating to the image formation magnification of the objective lens OBJ, when the structure in which the relationship of |a′/a|=|b′/b| is realized, is adopted, it has a function of the temperature correction for the DVD. Hereupon, FIG. 4 is a typical view, and actually, because image distances a′ and b′ are sufficiently smaller than the object distances a and b, in the above expression, they are operated as a′=b′. Hereupon, to the light flux of the wavelength λ2 used for the CD, because the second light source LD2 and the information recording surface SC of the CD are conjugate, the temperature correction which is conducted on the DVD, is not particularly necessary. However, the temperature correction for which the temperature correction technology as conventionally well known is used, may also be conducted.

As described above, according to the optical pick-up apparatus according to the present invention, because the light sources LD1 and LD2 of 2 wavelengths (λ1 and λ2) are respectively arranged on the optical axis L, which is different from the structure in which, the light source unit (2 wavelength 1 package) in which the light sources of 2 wavelengths are integrated, as conventionally well known, is used, and the light source of a side (for example, DVD side) for which the accuracy is required is arranged on the optical axis, and the light source of the other side (for example, CD side) is arranged at a position separated from the optical axis, in the principle, it can be structured so that the image height is not generated. Accordingly, it can be appropriately applied by the optical pick-up apparatus in which the recording of the information is possible, by so-called writing system one.

Further, when the light source of the 2 wavelength 1 package is used, in the structure, for both wavelengths, the light path lengths from the light source to the recording medium are almost equal, and it is necessary that the magnification is equal, and there is a problem that the optimum magnification can not be set for each wavelength, and in order to solve this problem, it is necessary that so-called infinite system structure is provided in which the collimator element is used and the parallel light is made incident on the objective lens, and there is a problem that the number of optical elements is increased. Further, because the light paths of both wavelengths are almost equal, there is a problem that it is difficult to conduct the optimized temperature correction for each of them.

However, in the optical pick-up apparatus according to the present invention, respective optimum magnifications can be selected for 2 wavelengths, and because it may also be a finite system structure, the number of optical elements can be suppressed.

Further, when the optical functional surface (diffractive structure) for the temperature correction is provided on the first coupling element CL1, the temperature correction which is specified to the DVD using the light flux of the wavelength λ1, can be conducted. Further, in the optical pick-up apparatus according to the present invention, in its structure, the temperature correction for the CD using the light flux of the wavelength λ2, is not particularly necessary. Accordingly, when the optical functional surface (diffractive structure) for the temperature correction is provided only on the first coupling element CL1, for both of the DVD and CD, the optical pick-up apparatus in which generation of nonconformity which accompanies the temperature variation is suppressed, can be obtained.

Further, in the optical pick-up apparatus shown in the present embodiment, in the high temperature situation, the diffracting action is given by the diffractive structure so as to be θ1′>θ1.

Accordingly, for example, as conventionally known, when the power of the diffraction by the diffractive structure is enhanced at the time of the temperature rise, as compared to the structure in which the emitting angle of the emitted light flux from the coupling lens, is not changed (θ1′=θ1), because the power of the diffraction is not necessary, for example, when the diffractive structure is structured by a plurality of concentric circular diffractive ring-shaped zones around the optical axis, the number of the diffractive ring-shaped zones can be suppressed, thereby, the production process of the coupling element can be simplified, or the production cost can be reduced.

Hereupon, of course, it is also possible to correct the temperature characteristic for the light flux of the wavelength λ2 emitted from the second light source, and in this case, it may be allowed when the first diffractive surface which corrects the temperature characteristic for the light flux of the wavelength λ1 emitted from the first light source LD1, is provided on the first coupling element CL1, and the second diffractive surface which corrects the temperature characteristic for the light flux of the wavelength λ2 emitted from the second light source LD2, is provided on the second coupling element CL2.

However, practically, when it is structured in such a manner that the correction of the temperature characteristic is conducted for the light source having shorter wavelength, because a pick-up in which actually there is no problem can be realized, the present invention is particularly characterized in that the temperature characteristic for the light flux of the wavelength λ1 emitted from the first light source LD1 is corrected. Particularly, when many diffractive elements are arranged in the light path, because it results in the lowering of the light amount, also from the viewpoint that the recording and reproducing of the information are assuredly conducted, the structure in which the number of diffractive elements is reduced, is preferable.

Further, it can also be structured in such a manner that the first coupling element CL1 and the second coupling element CL2 have not only a function as the coupling lens by which the divergent angle of the light emitted from the light sources LD1 and LD2 is reduced, but also have a function as the collimator lens. In such a case, the collimator lens shown by a one-dotted chain line is not necessary.

Hereupon, the light detector SE is a single one in the present example, however, 2 detectors may be provided at need, and it may also be allowed that the light detectors SE which respectively cope with the first light source LD1, the second light source LD2 are provided.

Hereupon, in the present example, the diffractive surface for the temperature correction is provided on the coupling lens CL1 which is the fist coupling element, and this can also be provided on the coupling lens CL2 which is the second coupling element. Furthermore, the diffractive surface for the temperature correction can also be provided on both coupling lenses.

Further, as the optical functional surface for the temperature correction, other than the diffractive structure, a structure in which the optical functional surface is divided into concentric circular minute ring-shaped zones, and a predetermined light path difference is generated (for each ring-shaped zone) for the light flux which passes each ring-shaped zone, can also be adopted.

(The Second Embodiment)

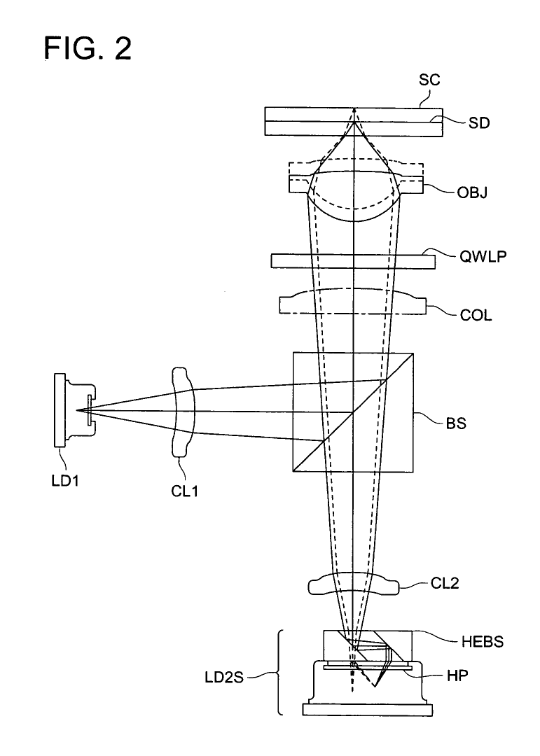

By using FIG. 2, the second embodiment will be described below. The same code is denoted for the structure in which the function is the same as in the first embodiment, and because the function is quite the same as in the first embodiment, the explanation will also be neglected.

A characteristic portion of the present embodiment is the structure corresponding to the invention of an item 7, and a holo-laser unit (a hologram laser unit) LD2S corresponds to it. This is the same as the structure written in the patent document 1, and the light source, light detector, and hologram element are integrally structured.

After the light flux of the wavelength λ1 reflected from the information recording surface SD of the first optical information recording medium passes the coupling lens CL2 which is the second coupling element, it is incident on a beam splitter with a hologram element HEBS. Then, the hologram element has the wavelength selectivity, the light path of the light flux of the wavelength λ1 is curved, and after the light path is curved again by a mirror, the light flux is light converged to the light detector through the diffraction plate HP.

Then, in the same manner, after the light flux of the wavelength λ2 reflected from the information recording surface SC of the second optical information recording medium passes the coupling lens CL2 which is the second coupling element, it is incident on a beam splitter with a hologram element HEBS. The light flux of the wavelength λ2 passes through it without stopping, and this light flux follows the light path different from the light flux of the wavelength λ1, and light converged on the light detector.

By such a structure, the light path length different for each wavelength of the light source can be set. Further, also in the present example, 2 light detectors can be provided.

When such a light source • light detector integrated unit is provided, there is an advantage that the adjustment or assembly of the optical pick-up apparatus can be simplified.

### EXAMPLE

Next, an example of the optical pick-up apparatus will be described. The arrangement of the optical pick-up apparatus such as the first and second light sources, the first and second coupling elements, a beam splitter and an objective lens, is the same as in FIG. 1.

In the present example, relating to the first coupling element CL1, an incident surface (the surface of the object side) is made a spherical surface, and an emitting surface (the surface of the image side) is made an aspheric surface, and the diffractive structure is provided on this emitting surface.

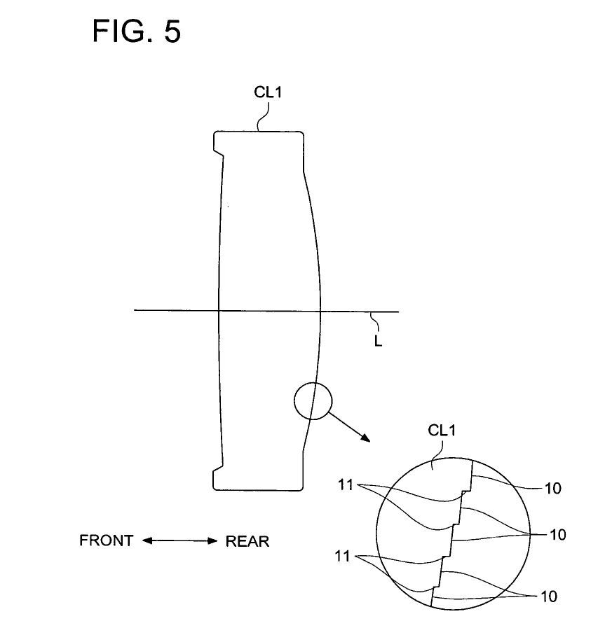

The diffractive structure is, as shown in an enlarged view encircled by a circle in FIG. 5, arranged almost in parallel with a plurality of concentric circular diffractive ring-shaped zones 10 around the optical axis L, and the optical axis L, and is structured by a step difference surface 11 which connects mutual 2 diffractive ring-shaped zones 10 adjoining in the diameter direction.

Hereupon, “almost in parallel” means, when an extending direction of the step difference surface 11 and the diffractive ring-shaped zone 10 is relatively compared, the step difference surface 11 more extends in the optical axis direction than the diffractive ring-shaped zone 10, and it is not necessary that the step difference surface 11 is in parallel with the optical axis direction.

Further, each step difference surface 11 is arranged facing the reverse side to the optical axis L side. Hereupon, “facing the reverse side to the optical axis side” means that the perpendicular from the surface of the step difference surface 11 extends to the direction separated from the optical axis L. Then, 2 diffractive ring-shaped zones 10 adjoining in the diameter direction, have a structure in which they are continued when the rear portion of the step difference surface 11 is connected to the outer peripheral portion of one hand diffractive ring-shaped zone 10, and the front portion of the step difference surface 11 is connected to the inner peripheral portion of the other diffractive ring-shaped zone 10.

In the second coupling element CL2, both of the incident surface and emitting surface are structured by aspheric surfaces. Further, in the first coupling element CL1 and the second coupling element CL2, both of them are set, in the normal situation, so that the incident light flux is emitted as the parallel light, that is, so that θ1=θ2=0 is satisfied.

Further, in the optical pick-up apparatus of the present example, the objective lens is made a plastic single lens, and a focal distance is set to about 2.0-2.4 mm, and the numerical aperture is set to 0.65. Naturally, the focal distance of the objective lens OBJ used for the optical pick-up apparatus is not limited to about 2.0-2.4 mm, and can appropriately be changed.

Further, in each kind of members (the first light source LD1, second light source LD2, coupling lenses CL1 and CL2, beam splitter BS, objective lens OBJ) constituting the optical pick-up apparatus, a movable portion is only the objective lens OBJ, and when the objective lens OBJ is moved from the reference position to the optical axis direction, the focusing in conducted. In Table 1, the lens data of the first coupling element CL1 is shown, and in Table 2, the lens data of the second coupling element CL2 is shown.

TABLE 1
Example CL1 lens data
f1: 15.0 mm
NA1: 0.113

| | Reference temperature +30° C. | | | | |
|---|---|---|---|---|---|
| The i-th | | | ni | ni | |
| surface | ri | di | (660 nm) | (666 nm) | note |
| 0 | | 14.45218 | | | Light |
| | | | | | source |
| 1 | ∞ | 0.0 | 1.0 | 1.0 | |
| 2 | 25.33905 | 1.20000 | 1.529334 | 1.525513 | |
| 3 | −5.51601 | 0.0 | 1.0 | 1.0 | Aspheric |
| | | | | | surface · |
| | | | | | Diffractive |
| | | | | | surface |
| 4 | ∞ | | | | |

*di expresses a displacement from the i-th surface to the
(i + 1)-th surface.
Aspheric surface data
The 3-rd surface
Aspheric surface coefficient
κ −4.0221 × E−1
A4 +4.5010 × E−4
A6 +5.6366 × E−6
Light path difference function (coefficient of
light path difference function: reference
wavelength 650 nm)
B2 +2.5092 × E−2

TABLE 2
Example CL2 lens data
f2: 9.0 mm
NA1: 0.183

| | Reference temperature +30° C. | | | | |
|---|---|---|---|---|---|
| The i-th | | | ni | ni | |
| surface | ri | di | (660 nm) | (666 nm) | note |
| 0 | | 8.17193 | | | Light |
| | | | | | source · |
| | | | | | light |
| | | | | | detector |
| 1 | ∞ | 0.0 | 1.0 | 1.0 | |
| 2 | 45.32842 | 1.40000 | 1.529334 | 1.525513 | Aspheric |
| | | | | | surface |
| 3 | −5.26659 | 0.0 | 1.0 | 1.0 | Aspheric |
| | | | | | surface |
| 4 | ∞ | | | | |

*di expresses a displacement from the i-th surface to the
(i + 1)-th surface.
Aspheric surface data
The second surface
Aspheric surface coefficient
κ −5.0000 × E−0
The third surface
Aspheric surface coefficient
κ −1.1239 × E−1
A4 +5.1654 × E−4
A6 +1.3069 × E−5
A8 +3.2340 × E−7

As shown in Table 1, in the first coupling element CL1, the wavelength of the light flux emitted from the first light source LD1 is, in the normal situation (reference temperature), 660 nm, and in the high temperature situation (+30° C. to the reference temperature), 666 nm. Then, in the normal situation (λ1=660 nm), it is set to the focal distance f₁=15.0 mm, image side numerical aperture NA1=0.113.

Further, as shown in Table 2, in the second coupling element CL2, when temporarily, the light flux of the wavelength λ1 (660 nm in the normal situation, 666 nm in the high temperature situation) is emitted from the second light source LD2, in the normal situation, it is set to the focal distance f2=9.0 mm, and image side numerical aperture NA2=0.183.

Hereupon, as described above, for the light flux of the wavelength λ2 used for the CD, because the coming and going light path is in a conjugate relationship, the temperature correction is not particularly necessary. Accordingly, the description of the focal distance and image side numerical aperture of the coupling element CL2 for the light flux of the wavelength λ2 will be neglected.

In Table 1, the surface numbers 2 and 3 respectively show the incident surface and emitting surface. Further, ri expresses the radius of curvature, di expresses the position of the optical axis L direction from the i-th surface to the (i+1)-th surface, ni expresses a refractive index in the normal situation, and n′i expresses a refractive index in the high temperature situation.

The emitting surface (the third surface) of the first coupling element CL1, the incident surface (the second surface) and emitting surface (the third surface) of the second coupling element CL2, are formed as the axial symmetric aspheric surface around the optical axis L, which is regulated by the arithmetic expression in which the coefficients shown in Table 1 and Table 2 are substituted into the following expression (Arith.-1).

(Arith.-1)

Aspheric Surface Shape Equation

$$X ( h ) = \frac{( {h}^{2} / {r}_{i} )}{1 + \sqrt{1 - ( 1 + κ ) {( h / {r}_{i} )}^{2}}} + {\sum }_{i = 0}^{n} {A}_{2 i} {h}^{2 i}$$

Herein, X(h) is an axis of the optical axis L direction (the advancing direction of the light is defined as positive), κ is a conical coefficient, A₂ᵢ is an aspheric surface coefficient, and h is the height from the optical axis.

Further, a pitch of the diffractive ring-shaped zone is regulated by an arithmetic expression in which a coefficient B₂ᵢ of the light path difference function shown in Table 1 is substituted into the light path difference function of Arith.-2.

(Arith.-2)

Light Path Difference Function

$$Φ ( h ) = {\sum }_{i = 1}^{n} {B}_{2 i} {h}^{2 i}$$

Hereupon, the blazed wavelength (reference wavelength) is 650 nm.

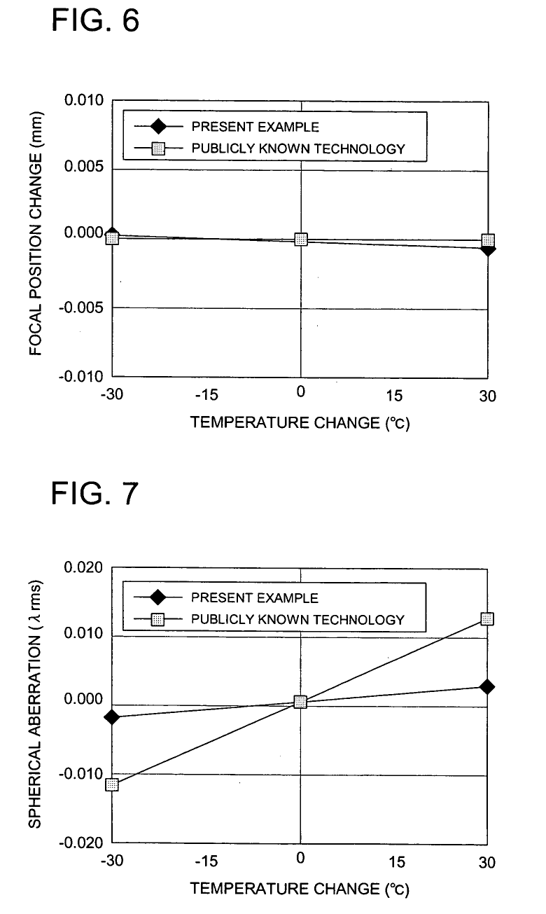

FIG. 6 shows a displacement amount for the temperature shows a displacement amount for the temperature change of the focal position formed on the light detector SE by the light flux of the wavelength λ1 which is emitted from the first light source LD1 and which is light converged/reflected on the information recording surface SD of the DVD, and shows a case where the optical pick-up apparatus of the present example is used, and a case where the optical pick-up apparatus in which the optical functional surface for the temperature correction according to the present invention is not provided, but the publicly known temperature correction technology is used, is used (hereinafter, it is expressed as “publicly known optical pick-up apparatus”).

The publicly known temperature correction technology indicates the technology by which, when the diffractive surface (diffractive structure) composed of a plurality of diffractive ring-shaped zones is provided on the optical element, ring-shaped zones is provided on the optical element, a change of a divergent angle or convergent angle of the emitted light flux for the temperature variation is controlled.

In the optical pick-up apparatus of the publicly known technology in the present example, an arrangement of the first and second light sources, the first and second coupling elements, beam splitter, and objective lens is the same as in FIG. 1, and a point that, on both of the first coupling element and the second coupling element, the above-described diffractive structure as the temperature correction technology is provided, is different from the optical pick-up apparatus of the present example.

The horizontal axis of the graph expresses the temperature change amount when the normal situation is the reference (temperature change 0° C.), and the vertical axis expresses the focal position change amount when the normal situation is reference (focal position change 0 mm).

When the optical pick-up apparatus of the present example is used, the focal position change amount is −0.0005 mm at the temperature change amount +30° C., and the focal position change amount is 0.0004 mm at the temperature change amount is −30° C. On the one hand, when the optical pick-up apparatus of the publicly known technology is used, even when the temperature is changed, the focal position change amount is 0 mm, that is, the focal position is not changed.

From the above description, in the change amount of the focal position for the temperature change, it can be seen that the optical pick-up apparatus of both the present example and the publicly known technology are placed within the range without practically a hindrance, and have almost the same performance.

FIG. 7 expresses the change amount of the spherical aberration generated on the information recording surface of the DVD by the temperature change.

The horizontal axis of the graph expresses the temperature change amount when the normal situation is the reference (temperature change 0° C.), and the vertical axis expresses the change amount of the spherical aberration when the normal situation is the reference (wave-front aberration 0.0 λrms).

When the optical pick-up apparatus of the present example is used, at the temperature change amount +30° C., the spherical aberration change amount is 0.002 λrms, and at the temperature change amount −30° C., the spherical aberration change amount is −0.002 λrms. On the one hand, when the publicly known optical pick-up apparatus is used, at the temperature change amount +30° C., the spherical aberration change amount is 0.012 λrms, and at the temperature change amount −30° C., the spherical aberration change amount is −0.012 λrms.

From the above description, it can be seen that, in the optical pick-up apparatus of the present example, the generation amount of the spherical aberration is more reduced as compared to the publicly known technology one. This is considered for the reason that, in the publicly known technology optical pick-up apparatus, the refractive index of the plastic objective lens is changed due to the temperature change, and the spherical aberration of the objective lens single body is remained without correction. On the one hand, in the optical pick-up apparatus of the present example, it is considered for the reason that, when the light flux of the wavelength λ1 emitted as the divergent light from the first coupling element due to the temperature change is incident on the objective lens as the divergent light as it is, an action by which the spherical aberration of the objective lens single body generated due to the temperature change, is eliminated (corrected), is generated.

As described above, in order to attain the temperature correction, in the publicly known technology optical pick-up apparatus, it is necessary that the diffractive structure as the temperature correction technology, is provided on both of the first coupling element and the second coupling element, however, in the optical pick-up apparatus according to the present invention, the diffractive structure to attain the temperature correction may be provided on only the first coupling element.

As described above, according to the optical pick-up apparatus, for the optical disk of the different format, an interchangeable optical pick-up apparatus in which the image height is not generated, and the temperature characteristic is good, and which is compact, can be realized.

Further, when the optical functional surface (diffractive structure) for the temperature correction is provided on only the first coupling element, for 2 kinds of optical information recording media, an optical pick-up apparatus by which the generation of the nonconformity accompanied by the temperature variation is suppressed, can be obtained.

What is claimed is:

1. An optical pickup apparatus for conducting reproducing and/or recording information for a first optical information recording medium having a substrate thickness t1 by using a first light source having a wavelength λ1 and for a second optical information recording medium having a substrate thickness t2 (t1<t2) by using a second light source having a wavelength λ2 (λ1<λ2), comprising:
an objective optical element for use in common for both of the first and second optical information recording mediums;
a photo-detector to detect light reflected from an information recording plane of the first and second optical information recording mediums;
a first coupling element to change a divergent angle of a first light flux coming from the first light source;
a second coupling element to change a divergent angle of a second light flux coming from the second light source;
a beam splitter provided between the objective optical element and the first coupling element; and
an optical functional surface provided to at least one of the first and second coupling elements and used for temperature compensation for a light flux of the wavelength λ1;
wherein the first and second light sources, the objective optical element, the photo-detector, the first and second coupling elements and the beam splitter are arranged such that:
a first light flux emitted from the first light source comes into the objective optical element through the first coupling element and the beam splitter and forms a converged light spot on an information recording plane of the first optical information recording medium,
a second light flux emitted from the second light source comes into the objective optical element through the second coupling element and the beam splitter and forms a converged light spot on an information recording plane of the second optical information recording medium, and
the first and second light fluxes forming the respective converged light spots are reflected from the respective information recording planes and thereafter pass through the objective optical element, the beam splitter and the second coupling element and come into the photo-detector.

2. The optical pickup apparatus of claim 1, wherein the optical functional surface used for temperature compensation for the first light source is provided on the first coupling element.

3. The optical pickup apparatus of claim 1, wherein the optical functional surface used for temperature compensation for the first light source is provided on the second coupling element.

4. The optical pickup apparatus of claim 1, further comprising:
a collimating element provided between the beam splitter and the objective optical element.

5. The optical pickup apparatus of claim 1, wherein the first coupling element has a collimating function.

6. The optical pickup apparatus of claim 1, wherein the second coupling element has a collimating function.

7. The optical pickup apparatus of claim 1, wherein the photo-detector and the second light source are integrated into a hologram laser unit comprising a hologram element and the first and second light fluxes reflected from the respective information recording planes come into the photo-detector with the aid of the hologram element.

8. The optical pickup apparatus of claim 1, wherein the photo-detector includes a first detecting section and a second detecting section and a hologram element having a wavelength selecting capability so that the first light flux of the wavelength λ1 reflected from the information recording plane of the first optical information recording medium comes into the first detecting section and the second light flux of the wavelength λ2 reflected from the information recording plane of the second optical information recording medium comes into the second detecting section.

9. The optical pickup apparatus of claim 1, wherein the optical functional surface for the temperature compensation is a diffractive structure.

10. The optical pickup apparatus of claim 1, wherein the following formulas are satisfied:
f1>f2
θ1=θ2
θ1′=θ2′
θ1′>θ1
where θ1 is an angle formed between marginal rays of a first light flux of the wavelength λ1 and the optical axis when the first light flux of the wavelength λ1 emitted from the first light source passes through the first coupling element before temperature rises,
θ2 is an angle formed between marginal rays of a first light flux of the wavelength λ1 and the optical axis on the supposition that the first light flux of the wavelength of λ1 is emitted from the second light source and when the first light flux of the wavelength λ1 passes through the second coupling element before temperature rises,
θ1′ is an angle formed between marginal rays of a first light flux of the wavelength λ1 to the optical axis when the light flux of the wavelength λ1 emitted from the first light source passes through the first coupling element after temperature rose,
θ2′ is an angle formed between marginal rays of a first light flux of the wavelength λ1 and the optical axis on the supposition that the first light flux of the wavelength of λ1 is emitted from the second light source and when the first light flux of the wavelength λ1 passes through the second coupling element after temperature rose,
f1 is a focal length of the first coupling element for a first light flux of the wavelength λ1, and
f2 is a focal length of the second coupling element for a first light flux of the wavelength λ1, and where when a light flux is diverged, a sign of θ1, θ1′ θ2 and θ2′ is positive.

11. The optical pickup apparatus of claim 9, wherein the diffractive structure comprises a plurality of concentric ring-shaped diffractive zones having a center on the optical axis and stepped surfaces arranged to be almost parallel to the optical axis, and wherein each of the stepped surfaces connects neighboring ring-shaped diffractive zones and arranged to face an opposite side of the optical axis.

12. The optical pickup apparatus of claim 11, wherein when an added length of an optical path by the diffractive structure is represented by an optical path difference function φ(h) defined by the formula of φ(h)=(B₂h²+B₄h⁴+B₆h⁶+ . . . Bₙhⁿ) where h is a height from the optical axis and Bn is a coefficient of n-th order optical path difference function (n is an even number), the following formula is satisfied:
B₂>0

13. The optical pickup apparatus of claim 11, further comprising a second diffractive structure including a plurality of concentric ring-shaped diffractive zones having a center on the optical axis on an optical surface of the objective optical element and the following formula is satisfied:
9<NL/f<39
where f is a focal length of the objective lens for a first light flux of the wavelength λ1, N (N≠0) is a diffraction order of a diffracted ray having the maximum diffraction efficiency among diffracted rays of the wavelength λ1 by the diffractive structure, and L is the number of diffractive zones of the second diffractive structure.
